(19) United States
(12) Patent Application Publication
(10) Pub. No.: US 2015/0241141 A1
(43) Pub. Date: Aug. 27, 2015

(54) TEMPERATURE MEASUREMENT BY MEANS OF AN OPTICAL WAVEGUIDE IN A PLATE HEAT EXCHANGER

(71) Applicant: LINDE AKTIENGESELLSCHAFT, München (DE)

(72) Inventors: Rainer FLüggen, Bichl (DE); Arndt-Erik Schael, Garching an der Alz (DE)

(21) Appl. No.: 14/433,971

(22) PCT Filed: Oct. 2, 2013
(86) PCT No.: PCT/EP2013/002975

§ 371 Date: Apr. 7, 2015

(30) Foreign Application Priority Data
Oct. 9, 2012 (EP) 12006984.4

(51) Int. Cl. F28F 3/02; G01K 11/32; G01K 1/14

(52) U.S. Cl. CPC F28F 3/02; G01K 1/143; G01K 11/32

(57) ABSTRACT

A plate heat exchanger, having a multiplicity of plates which run parallel to one another, wherein in each case a fin is arranged between two adjacent plates, with the result that a multiplicity of parallel ducts are formed, and an optical waveguide for measuring the temperature of the plate heat exchanger. The optical waveguide is arranged in a groove in a fin or a groove in a plate of the plate heat exchanger. A method for determining the temperature of a plate heat exchanger using the structure described.

The invention relates to a plate heat exchanger according to the preamble of claim 1, and to a method for determining the temperature of a plate heat exchanger.

Such a plate heat exchanger usually has a multiplicity of plates which are arranged parallel to one another, wherein in each case a fin is arranged between two adjacent plates, with the result that a multiplicity of parallel ducts, through which a medium can flow, are formed between adjacent plates. Toward the sides, the fins are bounded by what are referred to as side bars which are soldered to the adjacent plates. In this way, a multiplicity of parallel heat exchange passages of the plate heat exchanger are formed, with the result that, for example, media can be conducted past one another in counter-flow in the heat exchange passages in order to bring about indirect heat exchange.

In plate heat exchangers, hitherto, for example, sensors were mounted on the outside of the plate heat exchangers in order to measure the temperature. However, owing to the good thermal conduction such measurements are imprecise and indicate only an average temperature level. The temperatures in the interior of the plate heat exchanger therefore remain unknown. Furthermore, according to DE 10 2007 021 564 A1 temperatures in plate heat exchangers can be measured in principle with optical waveguides.

Taking this as a basis, the problem on which the present invention is based is therefore to make available a plate heat exchanger and a method for determining the temperature of a plate heat exchanger, which plate heat exchanger and method permit precise determination of the temperature of the plate heat exchanger.

This problem is solved by a plate heat exchanger having the features of claim 1.

Accordingly, there is provision that the optical waveguide is arranged in a groove in a fin or a groove in a plate of the plate heat exchanger. Said groove is preferably formed in the fin or plate here by milling, for example.

Said optical waveguide is preferably present in the form of an elongated element which is formed, in particular, by a glass fiber or has a glass fiber. However, optical fibers or optical waveguides composed of other materials are also conceivable.

According to one preferred embodiment of the invention, there is provision that the optical waveguide is arranged in a jacket surrounding the optical waveguide. Said jacket is preferably of tubular design, with the result that it encloses the optical waveguide completely in cross section. Said jacket is preferably formed from a metal such as, for example, a steel or aluminum.

According to one embodiment of the invention, the optical waveguide is arranged with respect to the fin or said plate in such a way that it has a meandering profile. That is to say the optical waveguide has a plurality of sections which are connected to one another in one piece or integrally molded onto one another in one piece, wherein in each case two adjacent sections preferably merge with one another via a section which is, in particular, curved in a U shape. Said curved sections preferably have a radius of curvature in the range from 1 cm to 5 cm, preferably 3 cm. Said (elongated) sections are preferably arranged parallel to one another with the result that said meandering profile of the optical waveguide is produced owing to the totality of the curved sections.

If the optical waveguide is arranged in a groove in a fin in the plate heat exchanger, said (straight) sections of the optical waveguide each run from a first outer edge region of the fin to a second outer edge region, lying opposite, of said fin which is parallel thereto, to be precise preferably transversely with respect to the ducts formed by the fin. The optical waveguide preferably extends here from the warm end of the plate heat exchanger to the cold end of the plate heat exchanger.

Alternatively to this, if the optical waveguide is arranged in a groove in a plate of the plate heat exchanger, there is preferably provision that said (straight) sections (analogously to the case mentioned above) each extend between a first outer edge region of the respective plate and a second outer edge region, lying opposite, of the plate which is parallel thereto.

Furthermore, the plate heat exchanger can basically also, per fin or plate, have a further optical waveguide which can also be positioned in a meandering shape, for example transversely with respect to the other optical waveguide.

When an optical waveguide is present per fin or plate, owing to the meandering profile of the optical waveguide, a 2-D distribution of the temperature of the plate heat exchanger can already be specified, since an optical waveguide of this kind has, along the direction of its extent, a plurality of measuring points for the temperature to be measured.

According to one embodiment of the invention, said fin in which the optical waveguide is arranged, or a corresponding plate with a groove in which the optical waveguide is arranged, is preferably an outermost fin of the plate heat exchanger or an outermost plate of the plate heat exchanger (covering plate).

Said fin or plate in which the optical waveguide is installed is preferably part of what is referred to as a dummy layer of the plate heat exchanger which is open to the surroundings. That is to say it is a layer or heat exchange passage of the plate heat exchanger through which process medium does not flow during correct operation of the plate heat exchanger.

However, as an alternative to this, the fin or said plate can also be used for the heat exchange process. For this purpose, the optical waveguide with its surrounding jacket is preferably soldered in a sealed fashion to the fin or plate, with the result that the corresponding heat exchange passage does not have any leakage to the surroundings.

Furthermore, the plate heat exchanger can have a multiplicity of the optical waveguides described above, wherein the individual optical waveguides are each arranged in a groove in an assigned fin or plate of the plate heat exchanger. In this way, a three-dimensional temperature distribution in the plate heat exchanger can be measured.

The optical waveguide or optical waveguides of the plate heat exchanger according to the invention are preferably connected to a measuring device which is configured to measure the temperature in the plate heat exchanger by means of said optical waveguide.

For this purpose, said measuring device is preferably designed to introduce light (optical signals) into the at least one optical waveguide and to evaluate in a known fashion light which is scattered back into the optical waveguide. In this context, use is made of the fact that the optical signals which are input and scattered back into the optical waveguide are highly temperature-dependent and are therefore suitable for measuring the temperature in the surroundings of the optical waveguide. For the evaluation of such optical signals of the optical waveguide there are a plurality of methods which permit the temperature to be determined with sufficiently high precision at any desired point on the optical waveguide.

In one preferred embodiment of the invention, the measuring device is configured and provided to evaluate light which is scattered back through the at least one optical waveguide and which is produced as a result of Raman scattering of the light which is introduced into the optical waveguide. In this context use is made of the fact that optical waveguides are generally fabricated from doped quartz (amorphous solid structure composed mainly of silicon dioxide). In such amorphous solid structures, lattice vibrations are induced by means of thermal effects. Such lattice vibrations are temperature dependent. Light which is incident on the molecules or particles in the optical waveguide therefore enter into an interaction with the electrons of the molecules. This interaction is also referred to as Raman scattering. The backscattered light can be divided into three spectral groups. In addition to the Rayleigh scattering, which corresponds to the wavelength of the input light, there are the so-called Stokes and the so-called anti-stokes components. In contrast to the Stokes components, which are shifted with respect to relatively high wavelengths and are only slightly temperature dependent, the anti-stokes components, which are shifted with respect to relatively low wavelengths, are clearly temperature dependent. The measuring device is therefore preferably designed to calculate the intensity ratio between the Stokes and the anti-stokes components, wherein the measuring device is preferably designed to calculate for this purpose a Fourier transformation of these two backscattered components and to compare it with a Fourier transformation of a reference signal. This provides the intensities of the two components over the length of the optical waveguide. The temperature for each point on the optical waveguide can therefore be determined by comparing the two intensities.

According to a further variant there is provision that the temperature is determined by evaluating the Rayleigh scattering. For this purpose, the measuring device preferably has a coherent frequency domain reflectometer (c-OFDR for coherent optical frequency domain reflectometer) in which light of a tunable laser is input into a Mach-Zehnder interferometer which distributes the light over two distances, wherein the optical waveguide forms one distance and the other distance is a reference distance of a certain length. The light portion from the reference distance is superimposed on the Rayleigh scattered light from the optical waveguide and detected. During the tuning of the laser wavelength, a periodic signal, whose frequency depends on the respective scattering location on the optical waveguide, is produced here at the detector. The individual frequencies of this signal, which can be obtained by means of a Fourier transformation, therefore correspond to the scattering locations of the optical waveguide; the amplitude of each frequency portion indicates the intensity of the respective reflection. In this context, resolutions of less than or equal to 0.1 mm can be obtained.

The Rayleigh scattering in an optical waveguide, such as, for example, a glass fiber, is produced by elastic scattering processes at local defects/faults in the optical waveguide. If such a glass fiber is sampled by means of a c-OFDR, a fluctuating intensity profile of the Rayleigh scattering, which is characteristic of the glass fiber, occurs along the glass fiber and said intensity profile is spatially stretched or compressed in the event of a change in temperature (change in the spatial extent of the fiber), as a result of which the temperature along the glass fiber can be calculated. The measuring device is correspondingly preferably configured to decompose the signal along the glass fiber into adjacent segments (greater than or equal to 1 mm) and to transform the corresponding signal into the frequency domain. Here, a fluctuating reflection pattern occurs for each segment as a function of the frequency. Changes in the temperature or stretching of the glass fiber bring about a frequency shift, which is, in particular, proportional to the change in temperature of the glass fiber in the respective segment. The measuring device is correspondingly preferably designed to determine the (local) temperature of the glass fiber or of the optical waveguide on the basis of the respective frequency shift.

In a further embodiment of the invention, the temperature is measured by evaluating optical signals such as are produced by Brillouin scattering of the optical waveguide. In this case, the temperature measurement is based on the locally resolved determination of the reference frequency between the primary light wave, introduced into the optical waveguide, and the wave which is induced and scattered back as a result of Brillouin scattering in the optical waveguide, the frequency of which wave is reduced compared to the primary wave as a function of the temperature. The measuring device is therefore preferably designed to introduce a pulse-shaped primary lightwave into the optical waveguide and to detect the backscattered light with time resolution for various frequency differences and, given knowledge of the pulse propagation time, to determine the frequency shift with local resolution on the basis of the change in temperature. In this embodiment of the invention, the temperature can therefore also be determined at any desired point on the optical waveguide by evaluating the (backscattered) optical signals.

In a further embodiment of the invention there is provision the temperature measurement by means of the evaluation of optical signals such as are produced by scattering at the Bragg grating. Bragg gratings are optical band filters which are inscribed into the optical waveguide and can be placed virtually as often as desired in the optical waveguide. The center wave number of the band-stop filter is obtained here from the Bragg condition. The spectral width of the band-stop filter depends not only on the grating length and the refractive index but also on the temperature. The measuring device is then correspondingly designed to determine the temperature at the respective location on the Bragg grating over the width of the band-stop filter for a given grating length, which varies over the optical waveguide, and refractive index.

Furthermore, the problem according to the invention is solved by a method for measuring the temperature in a plate heat exchanger, in particular using a plate heat exchanger according to one of the preceding exemplary embodiments, wherein the method according to claim 12 has the steps: inputting light into an optical waveguide which is arranged in a groove in a fin or in a groove in a plate of the plate heat exchanger, with the result that light in the optical waveguide is scattered back, wherein the optical waveguide has, in particular, a meandering profile, and measuring the temperature of the optical waveguide using the backscattered light (see above).

Further details and advantages of the invention will be explained by means of the following descriptions of the figures of exemplary embodiments, with reference to the figures, of which:

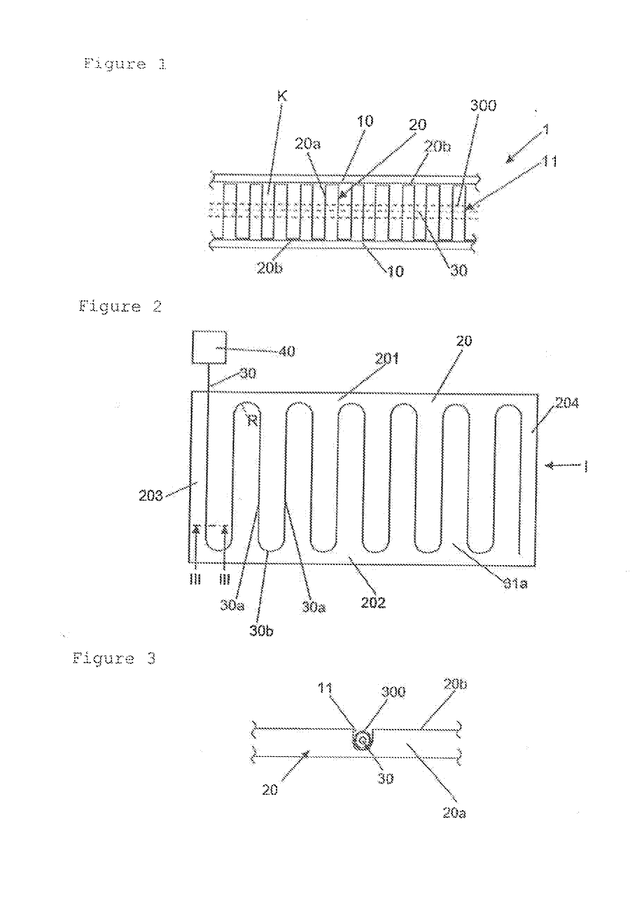

FIG. 1 shows a schematic sectional view of a detail of a plate heat exchanger which shows two plates of the plate heat exchanger which, together with a fin arranged between the plates, form a heat exchange passage of the plate heat exchanger;

FIG. 2 shows a schematic plan view of a fin or plate of a plate heat exchanger according to the invention with an optical waveguide arranged therein; and

FIG. 3 shows a side view of a fin or plate of the plate heat exchanger with a groove for receiving an optical waveguide.

FIG. 1 shows a sectional view of a plate heat exchanger 1. Such a plate heat exchanger 1 has a multiplicity of plates 10 which are arranged parallel to one another, wherein in each case a so-called fin 20 is arranged between two adjacent plates 10 of the heat exchanger 1, which fin 20 has a corrugated or step-shaped profile, with the result that a multiplicity of parallel ducts K are formed, in each of which a process medium can flow, which can then enter into indirect heat exchange with a process medium which is conducted in a parallel fin 20. In particular, the corrugated/folded shape of a fin 20 is formed by limbs 20a which are arranged parallel to one another and which extend, in particular, perpendicularly with respect to the plates 10, and by second limbs 20b which run parallel to the plates 10 and each connect to one another alternately at the top and at the bottom two first limbs 20a which lie opposite one another. The respective junction between the limbs 20a, 20b can also be rounded, with the result that the respective fin 20 has a corrugated profile. The fins 20 with the surrounding plates 10 are also referred to as heat exchange passages or layers of the plate heat exchanger 1.

In order to arrange an optical waveguide 30 in a layer of the plate heat exchanger 1, a groove 11 can be formed (for example by milling) either in said first or in said second limb 20a, 20b of a fin 20, said groove 11 being embodied in such a way that the optical waveguide 30 arranged therein has an essentially meandering profile. That is to say said optical waveguide 30 has, as shown in a plan view in FIG. 2, a multiplicity of parallel sections 30a which each run from a first edge region 201 of the fin 20 to a second edge region 202, lying opposite, of the fin 20, wherein in each case two adjacent sections 30a are integrally formed in one piece one against the other by means of a section 30b, curved in a U shape, of the optical waveguide 30.

FIG. 3 shows said groove 11 in cross section, i.e. as a recess in the first limbs 20a lying opposite one another and the (upper) second limbs 20b which connect said first limbs 20a.

The layers (heat exchange passages) in which optical waveguides 30 are arranged are preferably so-called dummy layers of the plate heat exchanger 1 through which there is no flow during correct operation of the heat exchanger 1. These dummy layers are each preferably located on opposite outer sides of the plate heat exchanger 1 which are formed by covering plates 10 of the plate heat exchanger 1. The dummy layers are therefore not involved in the respective process and are, in particular, open to the surroundings. However, such dummy layers can also be arranged between two heat exchange passages and do not necessarily have to be provided as an outermost layer.

As an alternative to the dummy layers, said optical waveguides 30 can also be arranged in layers or heat exchange passages of the plate heat exchanger 1 which are involved in the respective heat exchange process.

The optical waveguide 30 is preferably arranged in a correspondingly curved jacket (for example stainless steel sleeve) 300 which surrounds the optical waveguide 30 and preferably has an external diameter of 3.2 mm. These jackets 300 are positioned in the milled layers (grooves 11) and soldered to the respective fins 20. If a layer/heat exchange passage which is provided with an optical waveguide 30 is also to be used for process engineering, the jackets 300 are preferably fabricated from aluminum and are welded or soldered in a sealed fashion to the plates or side bars at the respective exit from the plate heat exchanger 1, i.e. at the respective side bar of the plate heat exchanger. In such a case, the respective fin has a sufficient depth, for example 9.5 mm, perpendicularly with respect to its plane of extent.

As an alternative to the arrangement of the optical waveguide 30 in a fin 20, the optical waveguide 30 can also be embedded in a plate 10 or a covering plate 10. In this case, said groove 11 is formed in the respective plate 10, wherein in such a case the respective plate or covering plate 10 has a thickness of, in particular, approximately 5 mm. The plates 10 which are equipped with an optical waveguide 30 are then soldered in the usual way to the further components of the plate heat exchanger 1 (fins, side bars).

With the abovementioned loop-shaped or meandering arrangement of the optical waveguide 30—the curved sections 30b preferably have a bending radius of 3 cm—a measuring point for measuring the temperature is obtained (when the Raman scattering is evaluated) at least approximately every 500 mm along the optical waveguide 30. This means that in a layer of 750 mm width and 5000 mm length there are over 100 measuring points available for measuring the temperature. The temperature distribution along the respective fin can therefore be specified in a two-dimensional fashion. The resolution can be increased considerably when the Rayleigh scattering is evaluated (see above).

If a plurality of optical waveguides are arranged one above the other in different heat exchange passages or heat exchange layers of the plate heat exchanger 1, there is also the possibility of specifying the temperature distribution in the plate heat exchanger 1 in a spatial (three-dimensional) fashion.

In order to measure the temperature by means of the respective optical waveguide 30, the optical waveguides 30 which are present are led out of the plate heat exchanger 1, preferably spliced to form a single optical waveguide (glass fiber), and coupled to a corresponding measuring device 40. The latter is designed to input light into the respective optical waveguide 30 and evaluate the backscattered light in order to determine the temperature in the known fashion (see above).

### LIST OF REFERENCE SYMBOLS

| | |
|---|---|
| 1 | Plate heat exchanger |
| 10 | Plate |
| 11 | Groove |
| 20 | Fin |
| 20a, 20b | Limb |
| 30 | Optical waveguide (glass fiber) |
| 30a | Sections |
| 30b | Curved sections |
| 40 | Measuring device |
| 201, 202, 203, 204 | Edge regions of the fin or plate |
| 300 | Jacket |
| K | Ducts |

1. A plate heat exchanger, having:
a multiplicity of plates which nm parallel to one another, wherein in each case a fin is arranged between two adjacent plates, with the result that a multiplicity of parallel ducts are formed, and
an optical waveguide for measuring the temperature of the plate heat exchanger,
characterized
in that the optical waveguide is arranged in a groove in a fin or a groove in a plate of the plate heat exchanger.

2. The plate heat exchanger as claimed in claim 1, characterized in that the optical waveguide is of elongate form, wherein the optical waveguide is formed, in particular, by at least one glass fiber.

3. The plate heat exchanger as claimed in claim 1, characterized in that the optical waveguide is arranged in a jacket which encloses the optical waveguide, wherein said jacket is of tubular design, wherein the jacket is formed from a metal.

4. The plate heat exchanger as claimed in claim 1, characterized in that the optical waveguide has a meandering profile.

5. The plate heat exchanger as claimed in claim 1, characterized in that the optical waveguide has a multiplicity of sections which run parallel to one another, wherein every two adjacent sections are connected in one piece to one another via, in each case, a curved section of the optical waveguide, wherein the respective, curved section has a radius (R) of curvature in the range from 1 cm to 5 cm.

6. The plate heat exchanger as claimed in claim 5, characterized in that the optical waveguide is arranged in the groove of said fin, said sections each extend from a first outer edge region of the fin to a second outer edge region, lying opposite, of said fin.

7. The plate heat exchanger as claimed in claim 5, characterized in that the optical waveguide is arranged in the groove in said plate, said sections each extend between a first outer edge region of the plate and a second outer edge region, lying opposite, of the plate.

8. The plate heat exchanger as claimed in claim 1, characterized in that said fin is an outermost fin of the plate heat exchanger.

9. The plate heat exchanger as claimed in claim 1, characterized in that said plate is an outermost plate of the plate heat exchanger in the form of a covering plate.

10. The plate heat exchanger as claimed in claim 1, characterized in that the ducts formed by said fin in which the optical waveguide is arranged are configured and provided such that during correct operation of the plate heat exchanger process media which are conducted in the plate heat exchanger do not flow through said ducts.

11. The plate heat exchanger as claimed in claim 1, characterized in that the plate heat exchanger has a multiplicity of optical waveguides, in particular in the form of glass fibers, which are each arranged in a groove in an assigned fin or a groove in an assigned plate of the plate heat exchanger.

12. A method for measuring the temperature in a plate heat exchanger, having the steps:
inputting light into an optical waveguide which is arranged in a groove in a fin or in a groove in a plate of the plate heat exchanger, with the result that light in the optical waveguide is scattered back, wherein the optical waveguide has a meandering profile, and
measuring the temperature of the optical waveguide using the backscattered light.

13. The plate heat exchanger as claimed in claim 3 characterized in that the jacket is formed of steel or aluminum.

14. The plate heat exchanger as claimed in claim 5, characterized in that the radius of curvature is 3 cm.

15. The plate heat exchanger as claimed in claim 1, characterized in that the ducts formed by said fin in which the optical waveguide is arranged are configured and provided such that during correct operation of the plate heat exchanger a process medium which is conducted in the plate heat exchanger does flow through said ducts.
